(19) United States
(12) Patent Application Publication
(10) Pub. No.: US 2025/0141942 A1
(43) Pub. Date: May 1, 2025

(54) METHOD AND APPARATUS FOR SUPPORTING AVATAR CALL IN WIRELESS COMMUNICATION SYSTEM

(71) Applicant: Samsung Electronics Co., Ltd., Suwon-si (KR)

(72) Inventors: Dongyeon KIM, Suwon-si (KR); Jaehyeon BAE, Suwon-si (KR); Hyunkoo YANG, Suwon-si (KR); Sungryeul RHYU, Suwon-si (KR)

(21) Appl. No.: 18/933,397

(22) Filed: Oct. 31, 2024

(30) Foreign Application Priority Data
Oct. 31, 2023 (KR) 10-2023-0148231

(51) Int. Cl. H04L 65/1089; H04L 65/1016; H04L 65/1104

(52) U.S. Cl. CPC H04L 65/1089; H04L 65/1016; H04L 65/1104

(57) ABSTRACT

The disclosure relates to a 5G or 6G communication system for supporting a higher data transmission rate. A method and one or more non-transitory computer-readable storage media for processing a control signal in a wireless communication system are provided. The method includes receiving a first control signal transmitted from a network entity, processing the received first control signal, and transmitting, to a network entity, a second control signal generated based on the processing.

### CROSS-REFERENCE TO RELATED APPLICATION(S)

This application is based on and claims priority under 35 U.S.C. § 119 (a) of a Korean patent application number 10-2023-0148231, filed on Oct. 31, 2023, in the Korean Intellectual Property Office, the disclosure of which is incorporated by reference herein in its entirety.

### BACKGROUND

### 1. Field

The disclosure relates to a method and an apparatus for supporting an avatar call in wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter-wave (mmWave) including 28 GHz and 39 GHz. In addition, it has been considered to implement 6^{th} generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input-multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, Layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step Random Access Channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

For an Internet protocol (IP) multimedia subsystem (IMS) multimedia call, whether the states and the conditions of a UE and 5G network are states and conditions in which the IMS multimedia call can be provided is identified during a call establishment procedure, and when the conditions fail to be satisfied, the call is not established, or the call is released when monitoring is performed after the establishment of the call and the conditions fail to be satisfied.

In a case of an IMS data channel-based three dimensional (3D) avatar call discussed in the 3rd generation partnership program (3GPP), the quality of a call may be responsive to the states and conditions of the UE and the network. In this case, if the 3D avatar call is disconnected or the call fails to be established whenever there is a change in the states and conditions of the UE and the network, a user cannot stably use services.

Aspects of the disclosure are to address at least the above-mentioned problems and/or disadvantages and to provide at least the advantages described below. Accordingly, an aspect of the disclosure is to provide a method for providing a 3D avatar call by utilizing avatar media processing assistance of a network according to a change in the states and conditions of a UE and the network.

Additional aspects will be set forth in part in the description which follows and, in part, will be apparent from the description, or may be learned by practice of the presented embodiments.

In accordance with an aspect of the disclosure, a method for processing a control signal in a wireless communication system is provided. The method includes receiving a first control signal transmitted from a base station, processing the received first control signal, and transmitting, to the base station, a second control signal generated based on the processing.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving a first control signal transmitted from a base station, processing the received first control signal, and transmitting, to the base station, a second control signal generated based on the processing.

According to embodiments of the disclosure, an IMS data channel-based session establishment procedure in which a 3D avatar call can be provided utilizing avatar media processing of a network according to a change in the states and conditions of a UE and the network can be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a 5G system structure according to an embodiment of the disclosure;

FIG. 2 illustrates an IMS network structure according to an embodiment of the disclosure;

FIGS. 3A and 3B illustrate examples of a network structure including a data channel server in a communication system according to various embodiments of the disclosure;

FIG. 4 illustrates an example of a network structure including a connection relationship between a 5G core network and an IMS network in a communication system according to an embodiment of the disclosure;

FIGS. 5A and 5B illustrate examples of avatar communication according to various embodiments of the disclosure;

FIGS. 6A and 6B illustrate examples of a method of establishing a data channel (DC) bootstrap session according to various embodiments of the disclosure;

FIGS. 7A, 7B, and 7C illustrate examples of a method of establishing a DC application session according to various embodiments of the disclosure;

FIG. 8 illustrates a configuration of a UE according to an embodiment of the disclosure; and

FIG. 9 illustrates a configuration of a network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The various embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the 3rd generation partnership project long term evolution (3GPP LTE) and 3GPP 5G standards will be used for the sake of descriptive convenience. However, the disclosure is not limited by these terms and names, and may be applied in the same way to systems that conform other standards.

To meet the demand for wireless data traffic having increased since deployment of 4^{th} generation (4G) communication systems, efforts have been made to develop an improved 5G or pre-5G communication system. Therefore, the 5G or pre-5G communication system is also called a “beyond 4G network” communication system or a “post LTE” system. The 5G communication system defined by 3GPP is called a “new radio (NR) system”.

The 5G communication system is considered to be implemented in ultrahigh frequency (mmWave) bands, (e.g., 60 GHz bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques have been discussed in 5G communication systems and applied to the NR system.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (COMPs), reception-end interference cancellation, and the like.

In the 5G system, hybrid frequency shift keying FSK and quadrature amplitude modulation (QAM) (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology.

Hereinafter, various embodiments of the disclosure will be described in detail with reference to the accompanying drawings. It should be noted that, in the accompanying drawings, the same or like elements are designated by the same or like reference signs as much as possible. Also, it should be noted that the accompanying drawings of the disclosure are provided to assist in understanding the disclosure, and the disclosure is not limited by the shapes or arrangements illustrated in the drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

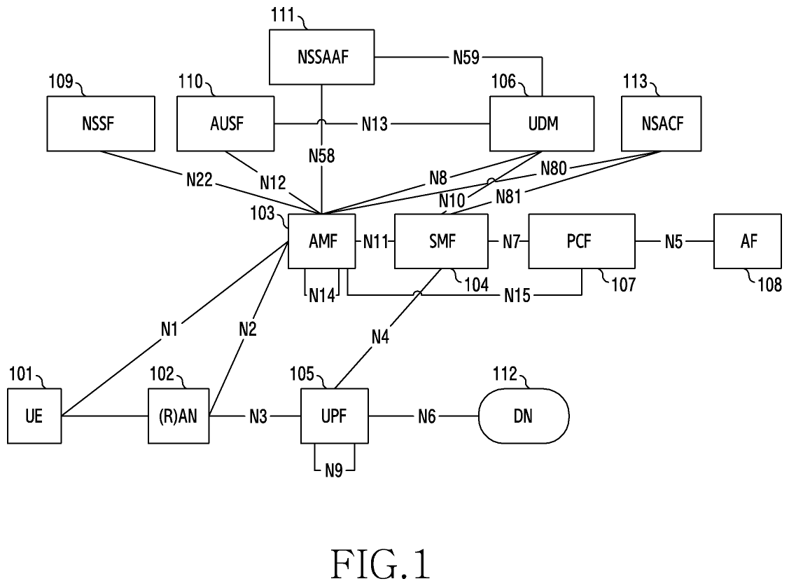

FIG. 1 illustrates a 5G system structure according to an embodiment of the disclosure.

Referring to FIG. 1, the 5G system architecture may include various elements (i.e., network functions (NFs)). FIG. 1 illustrates some of the various elements including an authentication server function (AUSF) device 110, a (core) access and mobility management function (AMF) device 103, a session management function (SMF) device 104, a policy control function (PCF) device 107, an application function (AF) device 108, a unified data management (UDM) device 106, a data network (DN) 112, a user plane function (UPF) device 105, a (radio) access network ((R) AN) 102, and a terminal, i.e., a user equipment (UE) 101. In addition, FIG. 1 illustrates a network slice selection function (NSSF) device 109 and a network slice specific authentication and authorization function (NSSAAF) device 111.

Each device illustrated in FIG. 1 may be implemented as a single server or device, or may be implemented as a network slice instance. When each device is implemented as a network slice instance, the same network slice instance or different network slice instances may be implemented in one server or device, or one network slice instance may be implemented in two or more servers or devices.

Respective NFs may support the following functions.

The AUSF 110 may process and store data for authentication of the UE.

The AMF 103 may provide a function for access and mobility management for each UE, and one UE may be basically connected to one AMF. Specifically, the AMF 103 may support functions such as inter-core network (CN) node signaling for mobility between 3GPP access networks, termination of a radio access network (RAN) CP interface (i.e., N2 interface), termination of non access stratum (NAS) signaling (N1), NAS signaling security (NAS ciphering and integrity protection), AS security control, registration management (registration area management), connectivity management, idle mode UE reachability (including control and execution of paging retransmission), mobility management control (subscription and policy), support of intra-system mobility and inter-system mobility, support of network slicing, SMF selection, lawful intercept (for an AMF event and an interface to an LI system), provision of transmission of a session management (SM) message between the UE and the SMF, transparent proxy for SM message routing, access authentication, access authorization including roaming authority check, provision of transmission of a short message service (SMS) message between the UE and a short message service function (SMSF), security anchor function (SAF), and/or security context management (SCM). Some or all of the functions of the AMF 103 may be supported within a single AMF instance operating using one AMF.

The DN 112 may refer to, for example, an operator service, Internet access, 3^{rd} party service, or the like. The DN 112 may transmit a downlink protocol data unit (PDU) to the UPF 105 or may receive, through the UPF 105, a PDU transmitted from the UE 101.

The PCF 107 may receive information about a packet flow from an application server and may provide a function of determining a policy such as mobility management and session management. Specifically, the PCF 107 may support functions such as support of a unified policy framework for controlling a network operation, provision of policy rules so that control plane function(s) (e.g., the AMF, the SMF, etc.) may enforce policy rules, and implementation of a front end to access related subscription information for policy decision within a user data repository (UDR).

The SMF 104 may provide a session management function, and when the UE has multiple sessions, the sessions may be managed by different SMFs, respectively. Specifically, the SMF 104 may support functions such as session management (e.g., session establishment, modification, and release, including tunnel maintenance between UPF and AN nodes), UE IP address allocation and management (selectively including authentication), selection and control of a UP function, traffic steering configuration for routing traffic to an appropriate destination in the UPF, termination of an interface toward policy control functions, enforcement of a control part of a policy and quality of service (QOS), lawful intercept (for an SM event and an interface to an LI system), termination of an SM part of a NAS message, downlink data notification, an initiator of AN specific SM information (transmission to the AN through N2 via the AMF), session and service continuity (SSC) mode decision of a session, and a roaming function. As described above, some or all of the functions of the SMF 104 may be supported within a single instance operating using one SMF.

The UDM 106 may store subscription data of a user, policy data, etc. The UDM 106 may include two parts, i.e., an application front end (FE) (not shown) and a user data repository (UDR) (not shown).

The FE may include a UDM-FE that is in charge of location management, subscription management, processing of credential, etc., and a PCF-FE that is in charge of policy control. The UDR may store data required for functions provided by the UDM-FE and a policy profile required by the PCF. The data stored in the UDR may include user subscription data including a subscription identifier, security credential, access and mobility-related subscription data, and session-related subscription data, and policy data. The UDM-FE may access subscription information stored in the UDR, and may support functions such as authentication credential processing, user identification handling, access authentication, registration/mobility management, subscription management, SMS management, and the like.

The UPF 105 may transmit a downlink PDU received from the DN 112 to the UE 101 via the (R) AN 102 and may transmit an uplink PDU received from the UE 101 to the DN 112 via the (R) AN 102. Specifically, the UPF 105 may support functions such as an anchor point for intra/inter RAT mobility, an external PDU session point of interconnection to a data network (DN), packet routing and forwarding, a user plane part of packet inspection and policy rule enforcement, lawful intercept, traffic usage reporting, an uplink classifier for supporting routing of a traffic flow to the DN, a branching point for supporting a multi-homed PDU session, QoS handling for a user plane (e.g., packet filtering, gating, uplink/downlink rate enforcement), uplink traffic verification (service data flow (SDF) mapping between a SDF and a QoS flow), transport level packet marking in an uplink and a downlink, downlink packet buffering, and downlink data notification triggering. Some or all of the functions of the UPF 105 may be supported within a single instance operating using one UPF.

The AF 108 may interact with a 3GPP core network to provide services (e.g., support functions such as application influence on traffic routing, network capability exposure access, interaction with a policy framework for policy control, and the like).

The (R) AN 102 may collectively refer to a new radio access network supporting both evolved universal terrestrial radio access (E-UTRA), which is an evolved version of 4G radio access technology, and New Radio (NR) access technology (e.g., gNB).

The gNB may support functions such as functions for radio resource management (i.e., radio bearer control, radio admission control, connection mobility control, dynamic allocation of resources to the UE in an uplink/downlink (i.e., scheduling)), Internet Protocol (IP) header compression, encryption of a user data stream and integrity protection, selection of an AMF 103 upon attachment of the UE 101 when routing to the AMF 103 is not determined from information provided to the UE 101, routing of user plane data to UPF(s) 105, routing of control plane information to the AMF 103, connection setup and release, scheduling and transmission of a paging message (generated from the AMF), scheduling and transmission of system broadcast information (generated from the AMF or operating and maintenance (O&M)), measurement for mobility and scheduling and measurement report configuration, transport level packet marking in an uplink, session management, support of network slicing, QoS flow management and mapping to a data radio bearer, support of a UE in an inactive mode, a NAS message distribution function, a NAS node selection function, radio access network sharing, dual connectivity, and tight interworking between the NR and the E-UTRA.

The UE 101 may refer to a user equipment. The user equipment may be referred to as a terminal, a mobile equipment (ME), or a mobile station (MS). In addition, the user equipment may be a portable device such as a laptop computer, a mobile phone, a personal digital assistant (PDA), a smartphone, or a multimedia device, or a non-portable device such as a personal computer (PC) and a vehicle-mounted device. The following will be described using the term UE or terminal.

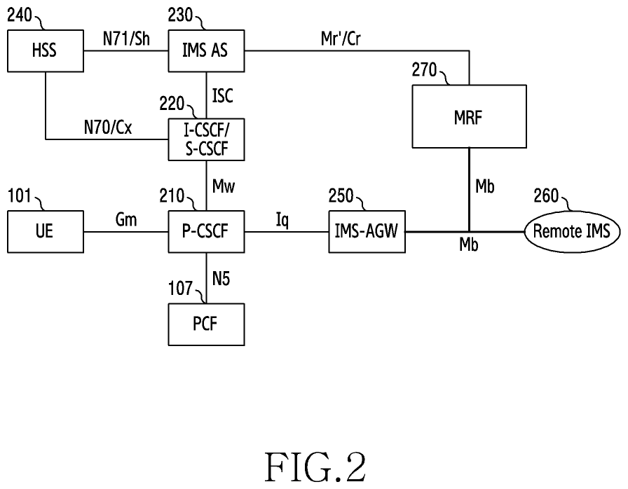

Although a network exposure function (NEF) and an NF repository function (NRF) are not shown in FIG. 1 for clarity of explanation, all the NFs shown in FIGS. 2, 3A, 3B, 4, 5A, and 5B described below may perform interaction with the NEF and the NRF when necessary.

The NRF will be described. The NRF (not shown in FIG. 1) may support a service discovery function. When receiving a second NF discovery request from a first NF instance, the NRF may provide, to the first NF instance, information of a second NF instance discovered after a second NF discovery operation. In addition, the NRF may maintain available NF instances and services supported by the NF instances.

For convenience of description, FIG. 1 illustrates a reference model in which the UE accesses one DN by using one PDU session, but the disclosure is not limited thereto.

The UE 101 may simultaneously access two (i.e., local and central) data networks by using multiple PDU sessions. In this case, two SMFs may be selected for different PDU sessions. Each SMF may have a capability to control both a local UPF and a central UPF within the PDU session.

Furthermore, the UE 101 may simultaneously access two (i.e., local and central) data networks provided within a single PDU session.

Control plane elements of the 5G core (5GC) may be considered as virtualized network functions (VNFs), and communication between the VNFs may be considered as providing services to different VNFs by one VNF upon RESTful-based application programming interface (API) exchange. An API-based communication interface between the VNFs may be referred to as a service-based interface (SBI).

In a 3GPP system, a conceptual link connecting between NFs in a 5G system is defined as a reference point. Reference points included in the 5G system architecture represented in FIG. 1 are as follows.
N1: Reference point between the UE and the AMF
N2: Reference point between the (R) AN and the AMF
N3: Reference point between the (R) AN and the UPF
N4: Reference point between the SMF and the UPF
N5: Reference point between the PCF and the AF
N6: Reference point between the UPF and the data network
N7: Reference point between the SMF and the PCF
N8: Reference point between the UDM and the AMF
N9: Reference points between two core UPFs
N10: Reference point between the UDM and the SMF
N11: Reference point between the AMF and the SMF
N12: Reference point between the AMF and the AUSF
N13: Reference point between the UDM and the authentication server function (AUSF)
N14: Reference point between two AMFs
N15: Reference point between the PCF and the AMF in a case of a non-roaming scenario, and reference point between the PCF and the AMF in a visited network in a case of a roaming scenario
N22: Reference point between the NSSF and the AMF
N58: Reference point between the NSSAAF and the AMF
N59: Reference point between the NSSAAF and the UDM
N80: Reference point between the network slice admission control function (NSACF) and the AMF
N81: Reference point between the NSACF and the SMF

In the following description, a terminal may refer to the UE 101, and the terms UE and terminal may be interchangeably used. In this case, unless a terminal is specifically defined additionally, the terminal should be understood as the UE 101.

The terminal accesses a data network (e.g., a network providing Internet services) through a 5G system and establishes a session. Each data network may be distinguished by using an identifier called a data network name (DNN). The DNN may be used to determine an NF related to a user plane, an interface between NFs, an operator policy, etc. when the terminal connects a network system to a session. The DNN may be used, for example, to select an SMF and UPF(s) for a PDU session, and may be used to select an interface (e.g., N6 interface) between a data network and a UPF for the PDU session. In addition, the DNN may be used to determine a mobile communication service provider's policy for application to the PDU session.

FIG. 2 illustrates an IMS network structure according to an embodiment of the disclosure.

A redundant description is omitted with reference to the contents of FIG. 1.

Referring to FIG. 2, a user equipment (UE) 101 may communicate with elements of an IP multimedia core network (IM CN) subsystem and another UE (not shown) located in a remote IMS network 260 through the IM CN subsystem. The IM CN subsystem may include a P-CSCF 210, an I/S-CSCF 220, an IMS AS 230, an IMS HSS 240, an IMS AGW 250, and/or an MRF 270, and the elements thereof may perform the following functions.
Proxy call session control function (P-CSCF) 210: The P-CSCF may perform a first contact point function for access to the IMS by the UE.
Interrogating/Serving CSCF (I/S-CSCF) 220: The I-CSCF may perform a contact point function for a subscriber of a network operator or a roaming user located at a service area of a current network operator. The S-CSCF may deal with an actual user session state of the network.
IMS application service (AS) 230: The IMS AS may provide and execute an Internet multimedia value added service. In addition, the IMS AS may influence a session initiation protocol (SIP) on behalf of a service supported to the operator network.
IMS home subscriber server (HSS) 240: The IMS HSS may perform a database role of storing information on a user.
IMS-access gateway (AGW) 250: The IMS-AGW is located in a media transmission path, and may manage a network address associated with inbound and outbound media streams.
Media resource function (MRF) 270: The MRF may perform various processing operations relate to the media streams. The MRF may be divided into a multimedia resource function controller (MRFC) performing control and a multimedia resource function processor (MRFP) performing media processing.

Referring to FIG. 2, interfaces between the elements may be represented by the following reference points.
Gm: Reference point Gm may support communication between the UE and the IM CN subsystem. For example, the UE may request network registration and session control through reference point Gm. An SIP to be described below may be used for reference point Gm.
Mw: Reference point Mw may support signaling message exchange and transmission between CSCFs.
ISC: Reference point ISC may support exchange of information required for the service provided by a service platform between the S-CSCF and the service platform (e.g., IMS AS).
Sh: Reference point Sh may support exchange of information required for a service provided by a service platform between the HSS and the service platform (e.g., IMS AS)
Cx: Reference point Cx may support transmission of information between the HSS and the CSCF.
Mr′/Cr: Reference point Mr′ may support interaction for session control between the IMS AS and the MRFC, and reference point Cr may support interaction for media control between the IMS AS and the MRFC.
Iq: Reference point Iq may support exchange of information required for allocation and releasing of a transport address between the P-CSCF and the IMS-AGW.
Mb: Reference point Mb may support IMS media transmission between IMS elements.

Referring to FIG. 2, the P-CSCF 210 supporting a service-based interface (SBI) may communication with a policy control function (PCF) 107, and this may be indicated as reference N5. The PCF 107 may support policy establishment and distribution for managing a network operation, and the P-CSCF 210 supporting the SBI may be considered as an application function (AF) using a service provided to another VNF by the PCF 107.

The IMS HSS 240 supporting SBI may communicate with the I/S-CSCF 220 supporting SBI through reference point N70, and may communication with the IMS AS 230 supporting SBI through reference point N71. Similarly, the I/S-CSCF 220 supporting SBI and the IMS AS 230 supporting SBI may be considered as AFs using the service provided by the IMS HSS 240 supporting SBI, and the functions provided through reference points N70 and N71 may be equivalent to the functions provided through reference points Cx and Sh, respectively.

The SIP is an application-layer signaling protocol specifying a procedure for mutually identifying intelligence UEs to be communicated on the Internet, finding the locations thereof, generating or deleting/changing a multimedia communication session therebetween. The SIP may be used for a transmission control protocol (TCP) and a UDP as a request/response structure for controlling generation, modification, and termination of a multimedia service session, such as Internet-based meeting, call, voice mail, event notification, and instant messaging, and in order to distinguish each user, an SIP uniform resource locator (URL) similar to an email address is used so that a service is provided without being dependent on the IP address. The SIP is based on text developed using most of the hypertext transfer protocol (HTTP) and the simple mail transfer protocol (SMTP) without changes, the implementation thereof is thus easy, and flexibility and expandability which enables generation of various services through combination with various other protocols used on the Internet. The SIP is a simpler protocol corresponding to H.323 of international telecommunication union telecommunication standardization sector (ITU-T), and a revision work is performed by a separated internet engineering task force (IETF) SIP working group after proposal as request for comments (RFC) 2543 by an IETF multiparty multimedia session control (MMUSIC) working group in 1999, and RFC 3261 standards were established in July 2002.

To provide a service (e.g., a real-time interaction service) in a communication system according to various embodiments of the disclosure, there is a need for a consent to media session constituting a service among UEs participating in the service. A communication system according to various embodiments of the disclosure may consent to the media sessions through session description protocol (SDP) negotiation to provide a service (e.g., a real-time interaction service).

The SDP may be included in the SIP message. The SDP is an American standard code for information interchange (ASCII) sentence-based protocol for describing multimedia session and related schedule information. The SDP transfers information on the media streams of the multimedia session for participating in the session, the multimedia session is defined as a set of media streams for a duration, and a time in which the session is performed does not need to be continuous. The multicast-based session on the Internet basically has two purposes of informing of the existence and time of the session and transferring participation information of the session, and a unicast environment has the later purpose. The contents of SDP information may include a session name and purpose, a session proceeding time, a session configuration medium, medium reception information, etc.

Hereinafter, various embodiments of the disclosure are described under the assumption that the service provided in the communication system is a real-time interaction service, but the disclosure is not limited thereto.

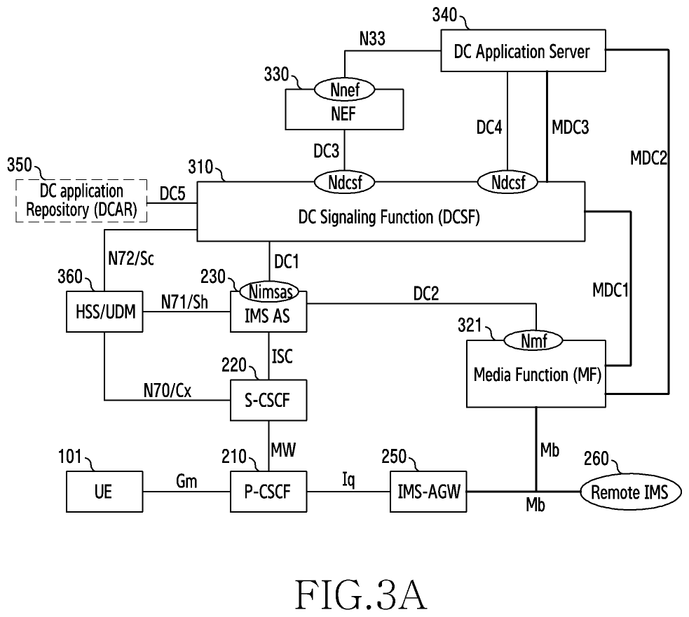

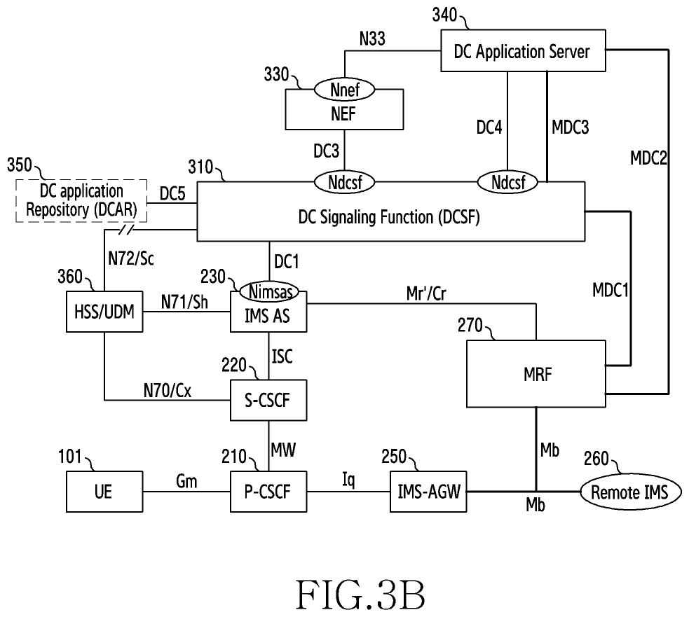

FIGS. 3A and 3B illustrate examples of a network structure including a data channel server in a communication system according to various embodiments of the disclosure.

A redundant description is omitted with reference to the contents of FIGS. 1 and 2.

Web application to provide a service (e.g., a real-time interaction service) in a communication system according to various embodiments of the disclosure may be provided from a data channel application server (DCAS) 340. The DCAS 340 may be located at an IMS operator network or a 3rd party network. In the disclosure, the web application provided by the DCAS 340 may be referred to as data channel application (DCA). A UE participating in a service (e.g., a real-time interaction service) provided by the DCA and another UE participating in the same service may exchange data required by the service by using a data channel (DC) directly or through an intermediate node, and may commutate with the DCAS 340 by using a bootstrap data channel (BDC).

Referring to FIGS. 3A and 3B, a communication system may include a UE 101 an IM CN subsystem. The UE 101 may communicate with elements of the IM CN subsystem another UE located at a remote IMS network 260 through the IM CN subsystem. The IM CN subsystem may include a P-CSCF 210, an I/S-CSCF 220, an IMS AS 230, an IMS HSS/UDM 360, an IMS AGW 250, a data channel signaling function 310, a media function (MF) 321, an NEF 330, a data channel application server 340, and/or a data channel application repository 350.

The data channel signaling function 310 may perform the following functions.
Management and control of data channel including bootstrap data channel
Data channel management and event generation/reception through communication with IMS AS
Management and distribution control of data channel application
Communication with 5G network function (NF) for provision of data channel application service
Proxy role for resource distribution of the DCAS 340

The data channel application repository 350 may store and manage data channel application, and may be positioned internal or external to the DCAS 340.

The media function (MF) 321 and the MRF 270 may perform the following functions.
Management and control of media resource to be transmitted to data channel including bootstrap data channel
Proxy role for data exchange between terminal point of data channel connected to the UE and another terminal point

The media function 321 and the MRF 270 provide the equivalent functions to different interfaces, and the operator may include one of or both the media function 321 and the MRF 270 in the DCAS 340 in consideration of capability with the UE and another network equipment.

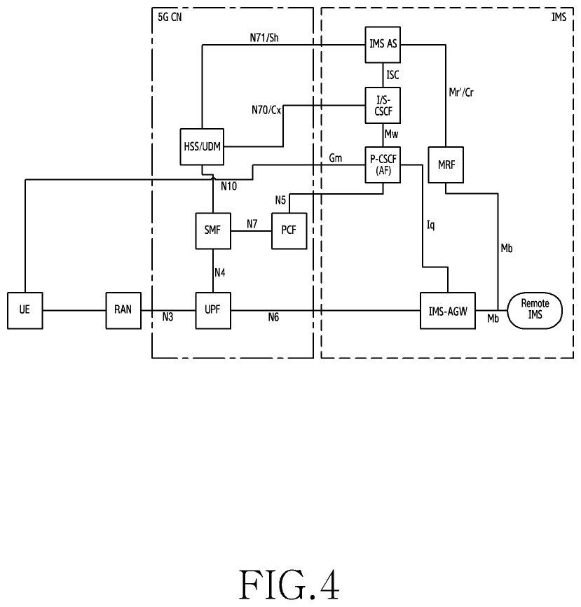

FIG. 4 illustrates an example of a network structure including a connection relationship between a 5G core network and an IMS network in a communication system according to an embodiment of the disclosure.

A redundant description is omitted with reference to the contents of FIGS. 1, 2, 3A, and 3B.

To establish an IMS session for making an IMS call, the UE may transmit an SIP INVITE message to the P-CSCF. Thereafter, according to an IMS session establishment procedure, the IMS session may be established through communication among the P-CSCF, S-CSCF, I-CSCF, IMS AS, and HSS.

In a case of a structure in which the IMS call of the UE goes through the 5G system, in other words, in a case of a structure in which data is transmitted through a 5G PDU session, the PCF may perform PDU session policy management including data resource management among the UE, RAN, UPF, and IMS-AGW. To this end, the P-CSCF may provide the PCF with IMS session information required for the data resource management of the IMS session. In this case, the P-CSCF may operate as an AF for the PCF, and may use an N5 interface. The PCF may perform, based on IM session information, UE policy or session policy management including data resource reservation, policy information determination including QoS rule determination, policy control request trigger (PCRT) generation, etc. The PCF may establish or identify, based on the IMS session information, a PDU session associated/corresponding with/to the corresponding IMS session.

That is, when the UE successfully establishes the IMS call, (1) an IMS session is established between IMS nodes, (2) a PDU session is established between 5G CN NFs, and a correlation between (1) the IMS session and (2) the PDU session may be identified by the PCF, based on IMS session information provided to the PCF by the P-CSCF.

In a case of a structure in which the IMS call of the UE goes through the 4G system, in other words, in a case of a structure in which data is transmitted through an EPS PDN session, the role of the PCF in the description may be performed by the PCRF.

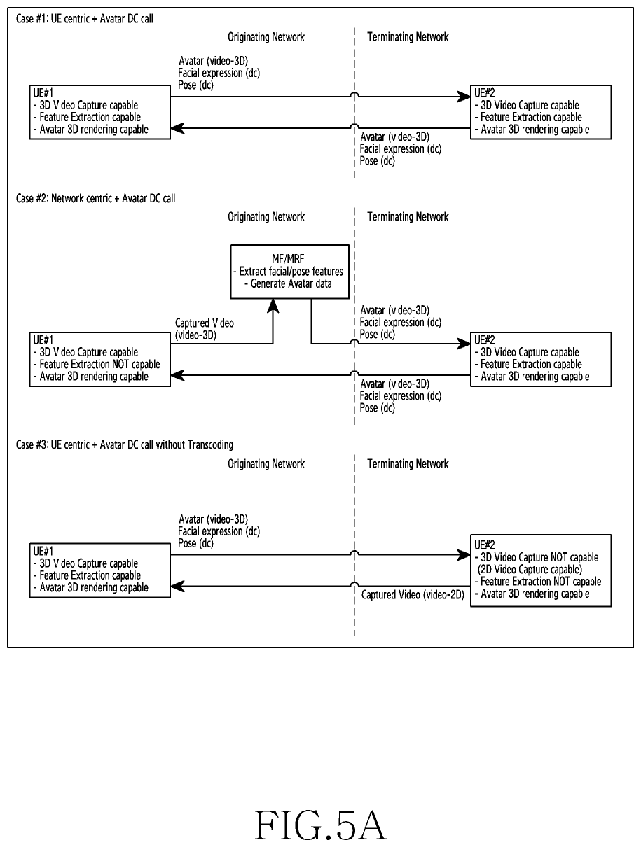

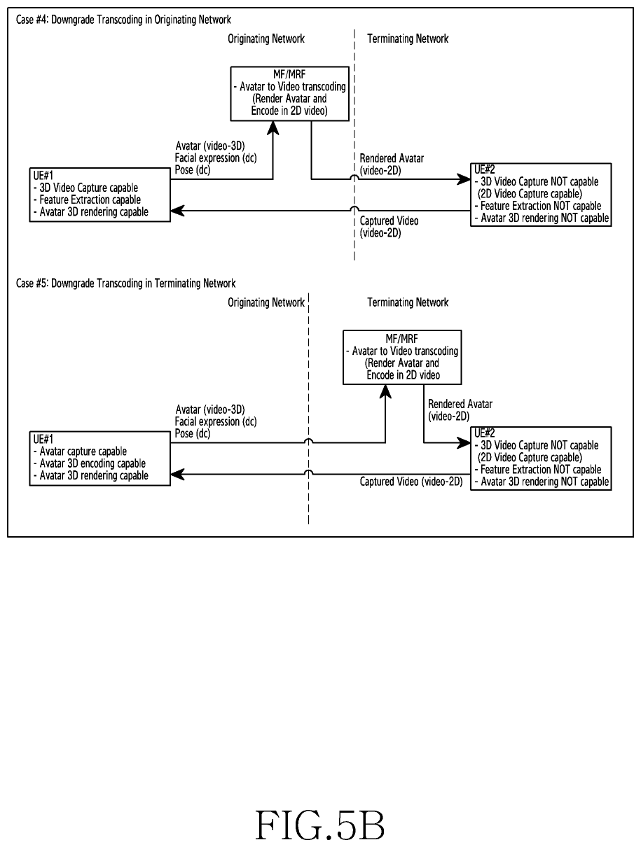

FIGS. 5A and 5B illustrate examples of IMS DC-based avatar communication in a communication system according to various embodiments of the disclosure.

Referring to FIGS. 5A and 5B, various types of avatar communication are possible according to: [A] a UE status (e.g., power, a signal, computing power, or an internal repository); [B] UE capabilities of avatar media (e.g., a 3D video capturing capability, a facial expression feature point extraction capability, or an avatar 3D rendering capability); [C] the availability of each UE capability of avatar media; [D] service capabilities of avatar call application (e.g., whether a UE can use an avatar media capability, more specifically, including a case where the UE has a 3D video capturing capability but fails to use the 3D video capturing capability because a camera function is temporarily turned off upon a user's selection or a UE battery state); [E] network capabilities of avatar media processing (e.g., including an avatar media processing capability of a network (facial expression feature point extraction capability and pose feature point extraction capability), an avatar 3D media rendering capability, and an avatar 3D media encoding capability of a network); [F] the availability of each network capability of avatar media processing (e.g., whether an avatar media processing capability can be used in a network, more specifically, including a case where the network has a capability of transcoding a video into avatar media, but the capability of transcoding the video into avatar media cannot be used because the transcoding function is temporarily turned off due to the complexity/state of the network); and/or [X] a preferred network MF option (e.g., preference to use of an MF of an originating network, preference to use of an MF of a terminating network, or preference to use of MFs of both the originating network and the terminating network).

Referring to FIG. 5A, Case #1 shows an example of a case where UE #1 and UE #2 can establish an IMS data channel-based avatar call without assistance related to avatar media processing of a network.

When both UE #1 and UE #2 have a 3D video capturing capability, a facial expression feature point extraction capability, and an avatar 3D rendering capability and use the same, UE #1 and UE #2 may transmit/receive session data including [1] 3D video data representing an avatar, [2] application data channel data representing facial feature point information, and [3] application data channel data representing pose feature point information. UE #1 and UE #2 may perform rendering on a user display by representing avatar media of a counterpart UE by using the information.

Case #2: shows an example of a case where UE #1 and UE #2 can establish an IMS data channel-based avatar call with assistance related to avatar media processing of a network.

When UE #1 does not have, among a 3D video capturing capability, a facial expression/pose feature point extraction capability, and an avatar 3D rendering capability, the facial expression/pose feature point extraction capability or cannot use the capability temporarily, UE #1 may transmit [4] 3D video data captured by UE #1 to a network (MF/MRF), and the network (MF/MRF) may extract a facial expression/pose feature point from the 3D video data captured by UE #1, and encode avatar data. The network (MF/MRF) may transmit, to UE #2, session data including [1] 3D video data representing an avatar, [2] application data channel data representing facial feature point information, and [3] application data channel data representing pose feature point information. UE #2 may perform rendering on a user display by representing avatar media of a counterpart UE (UE #1) by using the information. On the other hand, UE #2 may transmit, to UE #1, session data including [1] 3D video data representing an avatar, [2] application data channel data representing facial feature point information, and [3] application data channel data representing pose feature point information, and UE #1 may perform rendering on a user display by representing avatar media of the counterpart UE by using the information.

Case #3: shows an example of a case where UE #1 and UE #2 can establish a restricted IMS data channel-based avatar call without assistance related to avatar media processing of a network. In a case where UE #1 has a 3D video capturing capability, a facial expression feature point extraction capability, and an avatar 3D rendering capability and use the same, but UE #2 does not have the 3D video capturing capability and the facial expression/pose feature point extraction capability or fails to use the same temporarily, a restricted avatar call having a type in which an avatar 3D video is transmitted from UE #1 to UE #2 and a 2D video is transmitted from UE #2 to UE #1 can be established.

Case #4: shows an example of a case where UE #1 capable of processing avatar media with assistance related to avatar media processing of a network and UE #2 not capable of avatar media can establish an IMS data channel-based avatar call. UE #1 may transmit session data, to an originating side MF/MRF, session data including [1] 3D video data representing an avatar, [2] application data channel data representing facial feature point information, and [3] application data channel data representing pose feature point information. The originating side MF/MRF may perform rendering by representing an avatar 3D video of UE #1, and transcode the same into a 2D video to perform encoding. The MF/MRF may transmit, to UE #2, [5] data obtained by encoding a rendering image of a 3D video representing an avatar into a 2D video. On the other hand, UE #2 may transmit 2D video data to UE #1.

Case #5: shows an example of involving an assistance of avatar media processing of an originating side MF/MRF in the same UE #1 and UE #2 condition as in Case #4.

In determining whether to involve the originating side MF/MRF or the terminating side MF/MRF in Case #4 and Case #5, one or more elements of an avatar media processing capability of the originating or terminating side MF/MRF/whether the capability can be used, the UE, the network, a network MF option preferred in the application service, user subscriber information, and an avatar media processing type (e.g., transcoding from an avatar to low-complexity media such as video/audio/text (downgrade transcoding) and transcoding from the video/audio/text to high-complexity media such as an avatar (upgrade transcoding)) may be comprehensively considered.

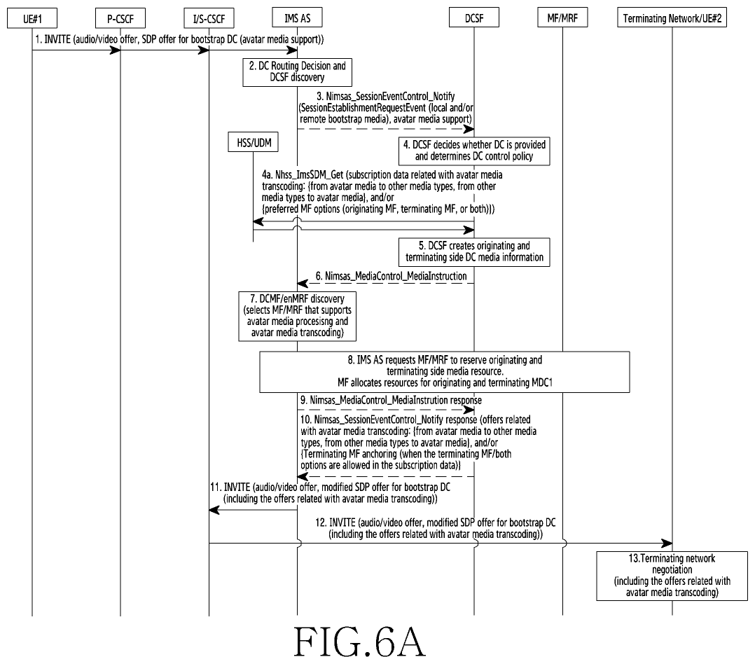

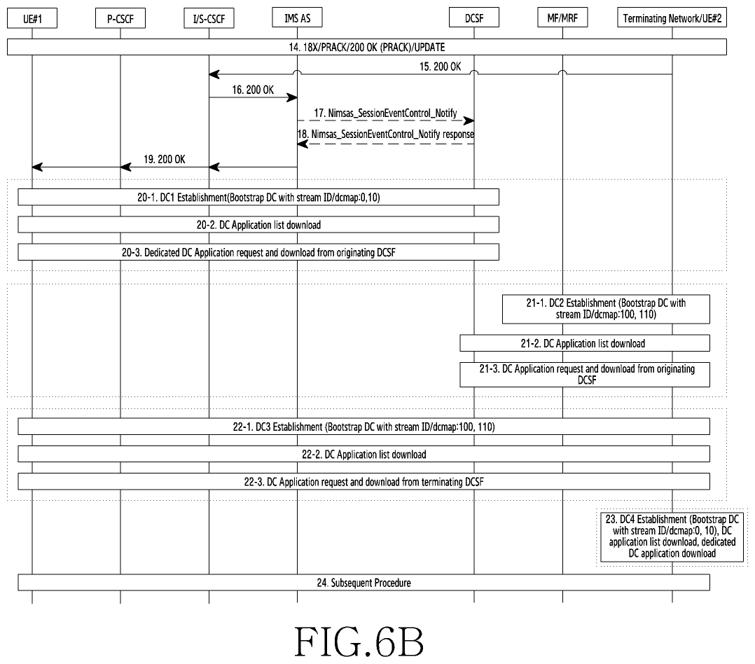

FIGS. 6A and 6B illustrate examples of a method of establishing a DC bootstrap session for an IMS DC-based avatar call in a communication system according to various embodiments of the disclosure.

Referring to FIGS. 6A and 6B, a UE and a network may establish a DC bootstrap session for an avatar call through the following procedure.

1. UE #1 may transmit an SIP INVITE request to an IMS AS through a P-CSCF and an S-CSCF in an originating network, and the request may include an initial SDP. The initial SDP may contain an SDP offer for a bootstrap data channel establishment request together with a bootstrap DC stream ID. For example, the SDP may include bootstrap data channel offers for both an originating side and a terminating side. In addition, the SIP INVITE may be an SIP re-INVITE performed after a setup of an IMS audio session. The offer for the bootstrap data channel establishment request may include information which can indicate a bootstrap data channel for avatar media support.

2. The IMS AS may identify user subscription data to determine whether the data channel call request needs to be notified to a DCSF. If the IMS AS determines, based on a user profile, that the request is to be notified to the DCSF, the IMS AS may select a DCSF for this user or search for and select a DCSF instance through an NRF, based on a local configuration. If the IMS AS determines, based on the user profile, that the request does not need to be notified to the DCSF or the DCSF determines that the DC request is not allowed, the IMS AS may continuously perform a normal IMS procedure to set up an MMTel session having no data channel bootstrap, and this may lead to deleting DC-related media information, updating the SIP INVITE message, and sending the same to an originating S-CSCF. When receiving information which can indicate a bootstrap data channel for media support through the SIP INVITE message or SDP offer, or determining that the SDP offer is a DC call request for a bootstrap data channel for avatar media support, the IMS AS may determine, based on the request for the bootstrap data channel for avatar media support and the user profile, that the request needs to be notified to the DCSF. In selecting the DCSF by the local configuration or searching for or selecting the DCSF through the NRF, the IMS may additionally consider that the request is a request for the bootstrap data channel for the avatar media support.

3. The IMS AS may notify a DC call event to the DCSF. The IMS AS may transmit a Nimas_SessionEventControl_Notify request message to the DCSF, and the message may include at least one of SessionEstabilshmentRequestEvent, a session ID, a calling ID, a called ID, a session case, an event initiator, Media InfoList, a DC stream ID, and information which can indicate that a bootstrap data channel for avatar media support. The SessionEstabilshmentRequestEvent may include information indicating whether the request is a request for bootstrap media of a local network (i.e., an originating network) or a request for bootstrap media of a remote network (i.e., a terminating network).

4. After receiving the DC control request, the DCSF may determine, based on parameters related to the data channel control request, a policy for a method for processing the bootstrap data channel establishment request. The related parameters may include at least one of the calling ID, called ID, DC stream ID, and information which can indicate a bootstrap data channel for avatar media support, and/or a DCSF service specified policy.

4a. Additionally, the DCSF may request and receive DCSF service specified user subscriber information from an HSS/UDM (indicating at least one of an HSS, a UDM, and an HSS+UDM, and referred to as “HSS/UDM” for convenience), and consider the same when determining a policy for bootstrap data channel establishment request processing. The DCSF may transmit a Nhss_ImsSDM_Get message to the HSS/UDM, this message may include a request for service specified subscriber information related to avatar media processing, and the HSS/UDM may provide the DCSF with the corresponding information. The service specified subscriber information related to the avatar media processing may include subscriber information related to avatar media transcoding. An example of the information related to the avatar media transcoding may include at least one of information on a media type to which transcoding of the avatar media is allowed (e.g., a video or audio in a case where transcoding from the avatar media to a video or audio is allowed), information on a media type from which transcoding of avatar media is allowed (e.g., a video or audio in a case where transcoding from a video or audio to avatar media is allowed), and [X] preferred network MF option (e.g., preference to use of an MF of an originating network, preference to use of an MF of a terminating network, and preference to use of MFs of both the originating network and the terminating network).

5. The DCSF may generate originating-side and terminating-side DC media information. If SessionEstablishmentRequestEvent requests local bootstrap media in stage 3, the DCSF may reserve, based on its own policy, originating-side MDC1 media information (which may include an MDC1 media terminal address) and terminating-side MDC1 remote bootstrap media information (which may include an MDC1 media terminal address) for a remote UE. The MDC1 media information corresponds to information required when the DCSF receives the UE's request for downloading an application from the MF or the MRF by the UE.

6. The DCSF may instruct, to the IMS AS, a method for setting up a boot strap data channel for the originating side and the terminating side with the MF, based on its own policy. The DCSF may use the Nimsas_MediaControl_MediaInstruction message for the instruction, and this message may include at least one of the session ID and the media instruction set. The MediaInstructionSet may include at least one of MDC1 media terminal addresses (an originating-side MDC1 media terminal address or a terminating-side MDC1 media terminal address for the remote UE, which is generated in stage 5 by the DCSF), a DC stream ID, and an alternative HTTP URL representing applications of an application list provided through an MDC1 interface.

7. The IMS AS may select an MF or an MRF. The IMS AS may make selection based on the local configuration, or search for or select an MF instance or MRF supporting a DC media function through the NRF. The DC media function may include an avatar media processing function and/or an avatar media transcoding function.

8. The IMS AS may perform an operation of instructing the MF or the MRF to allocate data channel media resources. In this case, a Nmf_MRM_Create service operation can be invoked, and this message may include a media termination descriptor list. The media termination descriptor may include media terminal information required when the MF/MRF allocate a resource for an originating-side MDC1 interface connection and a resource for a terminating-side MDC1 interface connection and media terminal information required when the MF/MRF allocates an originating-side Mb interface connection and a resource for a terminating-side Mb interface connection. The MF/MRF may allocate, based on the media terminal-related information provided by the IMS AS, the originating-side and terminating-side MDC1 resource and Mb resource, and provide the information to the IMS AS.

9. The IMS AS may respond to the MediaInstruction of stage 6. The Nims_MediaControl_MediaInstruction response message may be used in his response. Data channel media resource information for MDC1 may be included in this response.

10. The DCSF may store media resource information received in stage 9. In addition, the DCSF may respond to the received notification of the IMS AS in stage 3. Proposal information related to transcoding of avatar media may be include in this response. The example of the proposal information related to the transcoding of the avatar media may include at least one of information on a media type to which transcoding of the avatar media is allowed (e.g., a video or audio in a case where transcoding from the avatar media to a video or audio is allowed), information on a media type from which transcoding of avatar media is allowed (e.g., a video or audio in a case where transcoding from a video or audio to avatar media is allowed), a preferred network MF option (e.g., preference to use of an MF of an originating network, preference to use of an MF of a terminating network, and preference to use of MFs of both the originating network and the terminating network), and whether a terminating-side MF is involved (e.g., a case where from the user subscriber information, it is identified that the use of the MF of the terminating network is preferred or it is identified that the use of the MFs of the originating/terminating networks is preferred. The proposal information related to the transcoding of the avatar media may be considered as a result of negotiation between the IMS AS and the DC-related NF (DCSF and MF/MRF) based on at least one of information which can indicate a bootstrap data channel for avatar media support, received from the IMS AS in stage 3, user subscriber information received from the HSS/UDM in stage 4a, DC media information generated by the DCSF in stage 5, and/or data media resource information allocated by the MF/MRF by using the MDC1 interface in stage 8.

11. The IMS AS may update the INVITE message received from UE #1 in stage 1 and transfer the same to the S-CSCF or the I-CSCF so as to be transmitted to UE #2 of the terminating network. In updating the IMS AS INVITE message, the proposal information related to the transcoding of the avatar media, received in stage 10, or an offer related to avatar media transcoding and/or avatar media processing based on the proposal information may be added to the SDF offer requesting a bootstrap DC provided by UE #1 in stage 1.

12. The S-CSCF or the I-CSCF may transmit the INVITE message provided by the IMS AS in stage 11 to UE #2 of the terminating-side network.

13. UE #2 at the terminating-side network may perform a negotiation procedure with the entities, DC NFs, and/or UE #2 in the terminating network, based on an audio/video proposal or a DC bootstrap proposal provided by the INVITE message received in stage 12. In a case where it is supposed that the MF/MRF of the originating network is to anchor the MDC1 and/or Mb interface, a case where the MF/MRF of the terminating network requests to anchor the MDC1 and/or Mb interface, or a case where it is proposed to anchor the MDC1 and/or Mb interface by involving both the MFs/MRFs of both the originating network and the terminating network, the negotiation procedure may include a determination/negotiation procedure of the case in the terminating-side network. In addition, based on a result of the determination/negotiation procedure, data channel media resource information or the use of the MDC1 or Mb interface of the terminating-side network may be allocated. In addition, the negotiation procedure may include a determination/negotiation procedure of UE #2 for the proposal of the audio, video, and/or bootstrap DC media stream supporting the avatar media, included in the SIP INVITE.

14. UE #2 and the terminating network may provide an 18X response including an SDP answer to the bootstrap DC to the originating network. Based on the SDP answer, the MF/MRF may update data channel media resource information for UE #2.

15. UE #2 may return a 200 OK response to the originating network I-CSCF or S-CSCF.

16. The 200 OK response in stage 15 may be transferred to the IMS-AS.

17. The IMS AS may notify the DCSF of a successful session establishment event. This notification may use a Nimsas_SessionEventControl notify message, and this message may include SessionEstablishmentSuccessEvent, a session ID, a media info list.

18. The DCSF may response to the Nimsas notification request.

19. The 200 OK message may be transferred to UE #1, and this message may mean that the bootstrap DC has been established.

20-23. A bootstrap data channel may be established between UE #1/UE #2 and the terminating/receiving-side MF/MRF. UE #1/UE #2 may request a DC application list from the MF/MRF. The MF/MRF may replace the root URLs of the application with the alternative HTTP URL received in stage 6, and provide the same to the DCSF. The DCSF may provide UE #1 and UE #2 with the application list and the data channel applications through the MF/MRF.

24. Thereafter, an application DC session setup procedure may be performed.

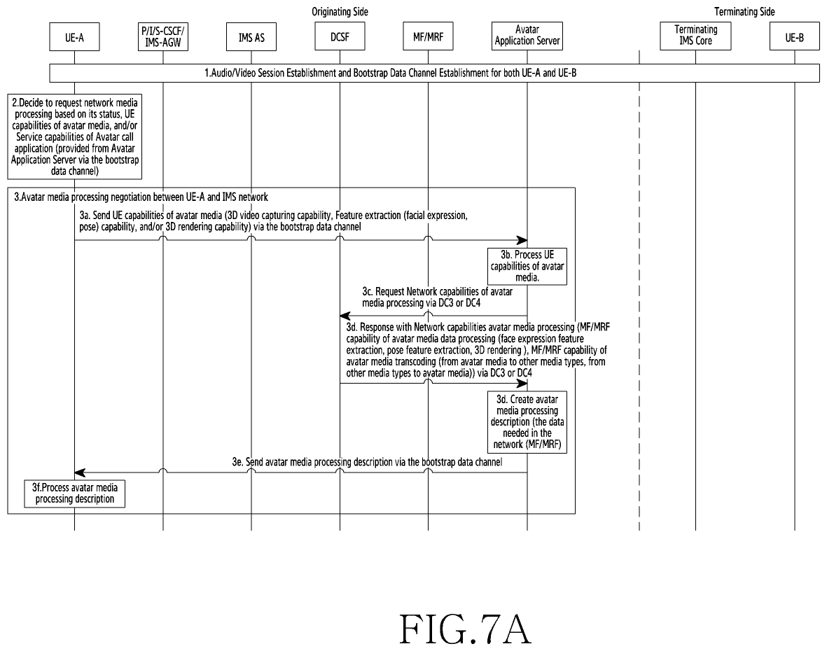

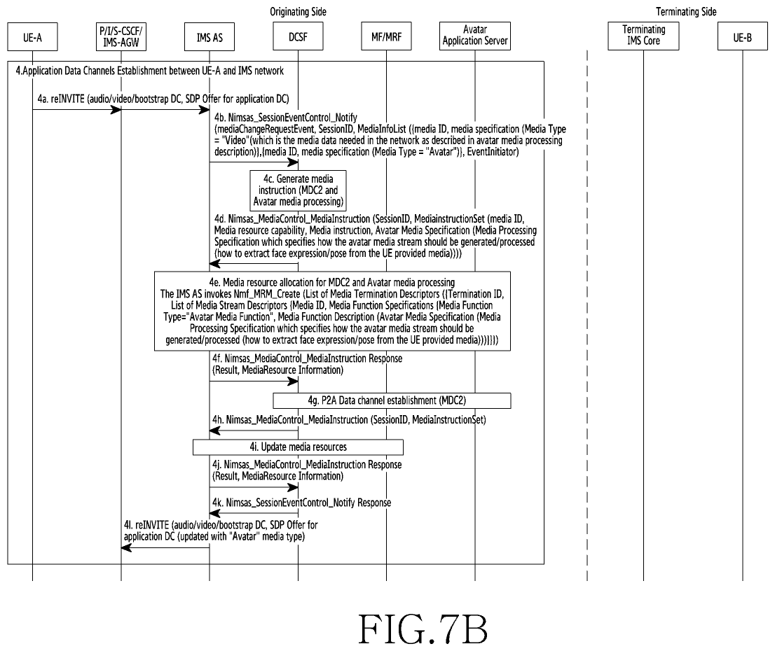

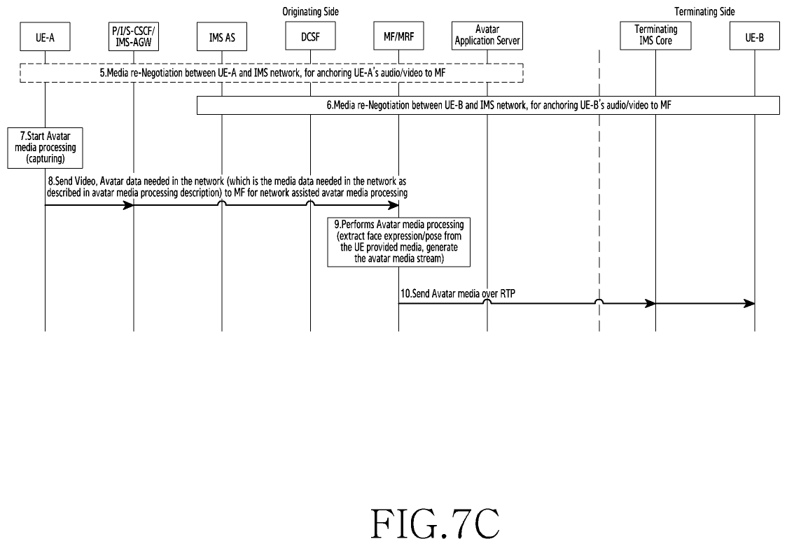

FIGS. 7A, 7B, and 7C illustrate examples of a method of establishing a DC application session for an IMS-DC based avatar call in a communication system according to various embodiments of the disclosure.

Referring to FIGS. 7A to 7C, a UE and a network may establish a DC application session for an avatar call through the following procedure.

1. UE-A and UE-B may set up an audio and/or video IMS session and a DC bootstrap session. The procedure described in FIGS. 6A and 6B may be used.

2. UE-A may request media processing from the network, based on at least one of [A] a UE status (e.g., power, a signal, computing power, or an internal repository), [B] UE capabilities of avatar media (e.g., a 3D video capturing capability, a facial expression feature point extraction capability, or an avatar 3D rendering capability), [C] the availability of each UE capability of avatar media (e.g., whether a UE can use an avatar media capability, more specifically, including a case where the UE has a 3D video capturing capability but fails to use the 3D video capturing capability because a camera function is temporarily turned off upon a user's selection or a UE battery state), and [D] service capabilities of avatar call application (e.g., whether a network has an avatar media processing and/or avatar media transcoding capability) downloaded from the avatar application server through the bootstrap DC in stage 1.

3. When UE-A determines that avatar media processing of the network is required and requests the media processing from the network in performing an avatar call with UE-B by UE-A in stage 2, based on the UE status, the UE capabilities of avatar media, the availability of each UE capability of avatar media, and/or service capabilities provided by the avatar call application, UE-A may perform a negotiation procedure of the avatar media processing with the IMS network.

3a. UE-A may transmit at least one of the UE capabilities of avatar media and whether the UE can use the capability of the avatar media to an avatar application server through the bootstrap DC.

3b. The avatar application server may perform processing of the UE capabilities of the avatar media and/or whether the UE can use the capability of the avatar media, received in stage 3a. More specifically, in performing avatar communication by UE-A, the avatar application server may determine, based on the capability/availability of the avatar media of the UE, an operation to be processed by the network. For example, when the UE does not have, among a 3D video capturing capability, a facial expression feature point extraction capability, and an avatar 3D rendering capability, the facial expression feature point extraction capability, or cannot use the same, it may be determined that the network needs to perform an operation of extracting a facial expression feature point from a 3D video captured by the UE and encoding the same to 3D avatar media. In another example, when the UE does not have or cannot use a 3D video capturing capability, a facial expression feature point extraction capability, and an avatar 3D rendering capability, it may be determined that the network needs to perform an operation of transcoding and encoding a 2D video captured by the UE to 3D avatar media.

3c. In order to determine whether the network can perform the operation that needs to be processed by the network in performing the avatar communication by UE-A, determined in stage 3b, the avatar application server may request, from the DCSF, [E] network capabilities of avatar media processing (e.g., an avatar media processing capability of the network (including a facial expression feature point extraction capability, a pose feature point extraction capability, an avatar 3D media rending capability, and an avatar 3D media encoding capability)), an avatar media transcoding capability of the network (including whether there is a capability of transcoding an avatar into a video, audio, and/or text, or whether there is a capability of transcoding a video, audio, and/or text into an avatar), and/or [F] the availability of each Network capability of avatar media processing (e.g., whether the network can use the avatar media processing capability, more specifically, including a case where the network has a capability of transcoding a video into avatar media, but the capability of transcoding the video into avatar media cannot be used because the transcoding function is temporarily turned off due to the complexity/state of the network). The avatar application server may transmit the request to the DCSF by using a DC3 or DC4 interface.

3d. The DCSF may determine the avatar media processing capability/availability of the MF/MRF upon the request in stage 3c, and respond to the avatar application server. The response may be transmitted to the avatar application server by using the DC3 or DC4 interface used in stage 3c.

3e. The avatar application server may determine, based on the avatar media processing capability/availability of the MF/MRF, received in stage 3d and the determination in stage 3d, whether the network can perform the operation to be processed by the network in performing avatar communication by UE-A, [G] may determine whether the UE can perform avatar communication with or without assistance of the network, and [H] may generate an avatar media processing descriptor. The avatar media processing descriptor may include information to be provided to the network (e.g., the MF/MRF) to perform the avatar communication by the UE with assistance of the network. For example, in a case where the UE does not have or cannot use, among a 3D video capturing capability, a facial expression feature point extraction capability, and an avatar 3D rendering capability, the facial expression feature point extraction capability in stage 3, when it is determined that the network needs to perform the operation of extracting a facial expression feature point from a 3D video captured by the UE and encoding the same to 3D avatar media, and it is determined in stage 3d that the network (MF/MRF) has the facial expression feature extraction capability and the avatar 3D media encoding capability and can use the same, UE-A may provide information indicating that the avatar communication can be performed with assistance of the network and/or information to be provided to the network (e.g., the MF/MRF) to perform avatar communication with assistance of the network. In this case, the information to be provided to the network by the UE-A may include 3D video data captured by the UE.

3f. UE-A may store the avatar media processing descriptor received in stage 3e, and process the same. When determining that the avatar communication cannot be performed with assistance of the network, UE-A may determine to suspend the session establishment procedure for the avatar call and establish a session for other types of calls. Alternatively, when there is no change in one of the UE status, the UE capabilities/availability of avatar media, service capabilities provided by the avatar call application, and the network capability/availability of the avatar media processing, UE-A may determine not to attempt the session establishment procedure for the avatar call again. When it is determined that the avatar communication can be performed with assistance of the network, UE-A may prepare an application data channel session establishment procedure.

4. When it is determined in stage 3 that UE-A can perform avatar communication with assistance of the network, UE-A may perform an application DC session establishment procedure for avatar communication with an IMS network.

4a. UE-A may transmit an SIP reINVITE (or SIP INVITE) message to the IMS AS through the P-CSCF or the S-CSCF. This message may include at least one of audio, a video, a bootstrap DC, and/or an SDP offer for an application DC. This message may include information on a method for processing the information to be provided by UE-A to the network for avatar communication in stage 3 (e.g., auxiliary information or metadata related to video data, auxiliary information or metadata required for facial expression feature point extraction, and auxiliary information or metadata required for avatar 3D rendering/encoding).

4b. The IMS AS may notify the DCSF of the occurrence of a media change request event. In this case, a Nimsas_SessionEventControl_Notify message may be used, and this message may include mediaChangeRequestEvent, SessionID, MediaInfoList, and EventInitiator. The MediaInfoList may include a list of information including {media ID, media specification}. For example, the information to be provided to the network by UE-A for avatar communication corresponds to auxiliary information or metadata related to video data, auxiliary information or metadata required for facial expression feature point extraction, and auxiliary information or metadata required for avatar 3D rendering/encoding, the message may include information on a method for processing the auxiliary information/metadata related to video data and a “video” media type, the auxiliary information/metadata required for the facial expression feature point extraction and an “avatar” media type, and/or information on a method for processing the auxiliary information/metadata required for the avatar 3D rendering/encoding.

4c. The DCSF may determine, based on the information (e.g., associated DC application binding information) received in stage 4b and/or a DCSF service specified policy, a policy for the method for processing the application DC establishment request. In addition, the DCSF may generate, based on the information received in stage 4b, media instructions including media resource information required for the use of an MDC2 interface and information required for avatar media processing by the MF/MRF.

4d. The DCSF may provide, based on the information generated in stage 4c, an application DC media descriptor required when the MF/MRF anchor an application DC session and information required when the MF/MRF perform avatar media processing. In this case, a Nimsas_MediaControl_mediaInstruction message may be used, and this message may include SessionID and MediainstructionSet. MediainstructionSet may include a media ID, a media resource capability, and a media instruction. As in the example mentioned in stage 4b, when the video data, the auxiliary information or metadata required for facial expression feature point extraction, and the auxiliary information or metadata required for avatar 3D rendering/encoding need to be provided to the MF/MRF, an avatar media specification may be included as information which can describe a method for extracting the facial expression/pose feature point from the video data.

4e. Resource allocation for MDC2 and avatar media processing may be performed. The IMS AS may provide the MF/MRF with the information received in stage 4d by using the a Nmf_MRM_Create message. Accordingly, the MF/MRF may allocate an MDC2 resource, and prepare avatar media processing (as in the example mentioned in stage 4d, an operation of extracting a facial expression/pose feature point from the video data and encoding the same to an avatar 3D video). The MF/MRF may provide the IMS AS with the information including a result of the MDC2 resource allocation and a result of the avatar media processing preparation.

4f. The IMS AS may provide the DCSF with the information received in stage 4e. In this case, a Nimsas_MediaControl_MediaInstruction response message may be used, and this message may include the media resource information and the result information received in stage 4e.

4g. The DCSF may transfer the media resource information received in stage 4f, and may transmit a peer to application (P2A) application DC establishment request to the avatar application server through DC3 or DC4. This request may include an MDC2 SDP offer provided by the MF/MRF in stage 4f. The Avatar application server may accept the P2A application DC establishment request and provide an MD2 SDP answer, and accordingly, may prepare to transmit traffic for UE #1 through MDC2.

4 h. The DCSF may request, based on the information (MDC2 media terminal information of the avatar application server) received in stage 4g, the IMS AS to update the resource of the MF/MRF. In this case, a Nimsas_MediaControl_MediaInstruction message may be used, and this message may include a session ID and MediaInstructionSet.

4i. The IMS AS and the MF/MRF may update the resource by using the MDC2 media terminal information.

4j. The IMS AS may respond to the DCSF. In this case, a Nimsas_MediaControl_MediaInstruction response may be used, and this message may include a result of the resource updating and MediaResource information.

4k. The DCSF may respond to stage 4b. In this case, a Nimsas_SessionEventControl_Notify response message may be used.

4l. The IMS AS may transfer, to UE-B, the reINVITE message received through the P-CSCF and the S-CSCF from the UE in stage 4a. In this case, the reINVITE message may be identical to the message provided by the UE in stage 4a, or may be a message having updated avatar media type-related information. More specifically, in stage 4a, the SDF offer for the video data captured by the UE and the application DC SDP offer including the metadata for the facial expression/pose feature point extraction are included, but in stage 4l, the message may be a message updated with an SDP offer for the avatar video data encoded by the network and an SDP offer including the metadata required for avatar media rendering.

5. A procedure for an Mb interface connection between UE-A and the MF/MRF may be performed.

6. A procedure for an Mb interface connection between UE-B and the MF/MRF may be performed.

7. UE-A may start avatar media processing. When UE-A performs avatar communication with assistance of the network, UE-A may perform media processing corresponding to the information to be provided to the network. For example, UE-A may generate auxiliary information or metadata related to video data and 3D video capturing, auxiliary information or metadata required for facial expression feature point extraction, and auxiliary information or metadata required for avatar 3D rendering/encoding.

8. UE-A may transmit, to the MF/MRF through the P-CSCF, the information to be provided to the network (MF/MRF) to perform avatar communication with assistance of the network.

9. The MF/MRF may perform avatar media processing based on the information received from UE-A. For example, based on the auxiliary information or metadata related to the video data, the auxiliary information or metadata required for facial expression feature point extraction, and the auxiliary information or metadata required for avatar 3D rendering/encoding, a facial expression feature point/pose feature point may be extracted from the video information captured by UE-A, and avatar 3D media encoding may be performed.

10. The MF/MRF may transmit the avatar media to UE-B.

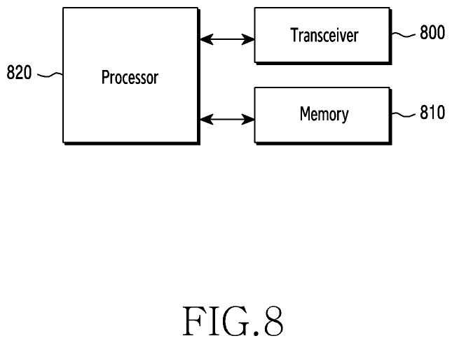

FIG. 8 illustrates a configuration of a UE according to an embodiment of the disclosure.

A UE according to an embodiment of the disclosure may include a processor 820 that controls an overall operation of the UE, a transceiver 800 that includes a transmitter and a receiver, and memory 810. The disclosure is not limited thereto, and the UE may include elements more or fewer than those illustrated in FIG. 8. The UE of FIG. 8 may correspond to the UE in FIGS. 1, 2, 3A, 3B, 4, 5A, 5B, 6A, 6B, and 7A to 7C.

According to an embodiment of the disclosure, the transceiver 800 may transmit/receive a signal to/from other network entities. The signal transmitted/received to/from other network entities may include control information and data. In addition, the transceiver 800 may receive a signal through a wireless channel, output the signal to the processor 820, and transmit the signal output from the processor 820 through the wireless channel.

According to an embodiment of the disclosure, the processor 820 may control the UE to perform one of the above embodiments of the disclosure. The processor 820, the memory 810, and the transceiver 800 are not necessarily implemented as separate modules, and may be implemented as one element such as a single chip. The processor 820 and the transceiver 800 may be electrically connected. In addition, the processor 820 may be an application processor (AP), a communication processor (CP), a circuit, an application-specific circuit, or at least one processor.

According to an embodiment of the disclosure, the memory 810 may store a basic program for operating the UE, an application program, and data such as configuration information. In particular, the memory 810 provides stored data according to a request of the processor 820. The memory 810 may include a storage medium such as read-only memory (ROM), random-access memory (RAM), a hard disk, a compact disc (CD)-ROM, or a digital versatile disc (DVD), or a combination of storage media. In addition, multiple memories 810 may be provided. In addition, the processor 820 may perform embodiments of the disclosure, based on a program for performing the embodiments of the disclosure stored in the memory 810.

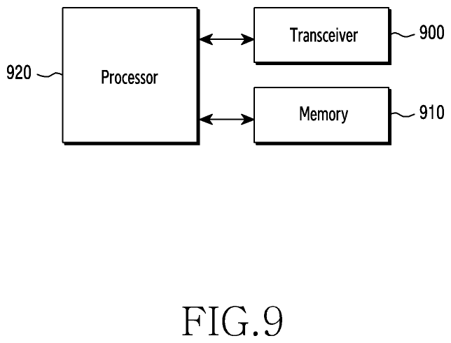

FIG. 9 illustrates a configuration of a network entity according to an embodiment of the disclosure.

A network entity according to an embodiment of the disclosure may include a processor 920 that controls an overall operation of the network entity, a transceiver 900 that includes a transmitter and a receiver, and memory 910. The disclosure is not limited thereto, and the network entity may include elements more or fewer than those illustrated in FIG. 9. The network entity of FIG. 9 may correspond to the network entity (or network function) in FIGS. 1, 2, 3A, 3B, 4, 5A, 5B, 6A, 6B, and 7A to 7C.

According to an embodiment of the disclosure, the transceiver 900 may transmit/receive a signal to/from at least one of other network entities or a UE. The signal transmitted/received to/from at least one of the other network entities or the UE may include control information and data.

According to an embodiment of the disclosure, the processor 920 may control the network entity to perform one of the above embodiments of the disclosure. The processor 920, the memory 910, and the transceiver 900 are not necessarily implemented as separate modules and may be implemented as one element such as a single chip. The processor 920 and the transceiver 900 may be electrically connected. In addition, the processor 920 may be an application processor (AP), a communication processor (CP), a circuit, an application-specific circuit, or at least one processor.

According to an embodiment of the disclosure, the memory 910 may store a basic program for operating the network entity, an application program, and data such as configuration information. In particular, the memory 910 provides stored data according to a request of the processor 920. The memory 910 may include a storage medium such as a ROM, a RAM, a hard disc, a CD-ROM, or a DVD, or a combination of storage media. In addition, multiple memories 910 may be provided. In addition, the processor 920 may perform embodiments of the disclosure, based on a program for performing the embodiments of the disclosure stored in the memory 910.

It should be noted that the above-described configuration diagrams, illustrative diagrams of control/data signal transmission methods, illustrative diagrams of operation procedures, and structural diagrams are not intended to limit the scope of the disclosure. That is, all the constituent elements, entities, or operation steps described in the embodiments of the disclosure should not be construed as being essential elements for the implementation of the disclosure, and even when including only some of the elements, the disclosure may be implemented without impairing the true of the disclosure. Also, the above respective embodiments may be employed in combination, as necessary. For example, the methods proposed in the disclosure may be partially combined with each other to operate a network entity and a terminal.

The above-described operations of a base station or terminal may be implemented by providing any unit of the base station or terminal device with a memory device storing corresponding program codes. That is, a controller of the base station or terminal device may perform the above-described operations by reading and executing the program codes stored in the memory device by means of a processor or central processing unit (CPU).

Various units or modules of an entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof. That is, it will be apparent to those skilled in the art that other variants based on the technical idea of the disclosure may be implemented. Also, the above respective embodiments may be employed in combination, as necessary. As an example, the methods proposed in the disclosure may be partially combined with each other to operate a base station and a terminal. Moreover, although the above embodiments have been described based on the frequency division duplex (FDD) LTE system, other variants based on the technical idea of the embodiments may also be implemented in other communication systems such as time division duplex (TDD) LTE, and 5G, or NR systems.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. Moreover, other variants based on the technical idea of the embodiments may also be implemented in various systems such as FDD LTE, TDD LTE, and 5G or NR systems.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an IMS (internet multimedia subsystem) AS (application server) in a wireless communication system, the method comprising:
receiving, from a first user equipment (UE), a first message including a first SDP (session description protocol) offer for a first media from the first UE;
transmitting, to a data channel signaling function (DCSF) entity, a second message for notifying media change request event;
receiving, from the DCSF entity, a third message including information on an avatar media processing; and
transmitting, to a second UE, a fourth message including a second SDP offer for a second media from a network entity.

2. The method of claim 1,
wherein the first message further includes information on processing first metadata for avatar communication, and
wherein the first metadata includes assistance information on at least one of the first media, an extraction of feature points, avatar encoding, or avatar rendering.

3. The method of claim 1,
wherein the fourth message further includes information on processing second metadata for avatar communication, and
wherein the second metadata includes assistance information on at least one of the second media, an extraction of feature points, avatar encoding, or avatar rendering.

4. The method of claim 1,
wherein the network entity includes at least one of a media function (MF) entity or media resource function (MRF) entity.

5. The method of claim 1,
wherein the first message includes a SIP (session initiation protocol) reinvite message, and
wherein the second message includes Nimsas_SessionEventControl_Notify message.

6. A method performed by a data channel signaling function (DCSF) entity in a wireless communication system, the method comprising:
receiving, from an IMS (internet multimedia subsystem) AS (application server), a first message for notifying media change request event;
generating a media instruction for an avatar media processing; and
transmitting, to the IMS AS, a second message including information on the avatar media processing.

7. The method of claim 6,
wherein the first message further includes information on processing first metadata related to the avatar media processing, and
wherein the first metadata includes assistance information on at least one of a media, an extraction of feature points, avatar encoding, or avatar rendering.

8. The method of claim 6, further comprising:
receiving, from the IMS AS, a third message including media resource information; and
transmitting, to an avatar application server, a first request for application data channel establishment and the media resource information.

9. The method of claim 8, further comprising:
transmitting, to the IMS AS, a second request for updating media resource for a network entity.

10. The method of claim 9,
wherein the first message includes Nimsas_SessionEventControl_Notify message, and
wherein the network entity includes a media function (MF) entity or media resource function (MRF) entity.

11. An IMS (internet multimedia subsystem) AS (application server) in a wireless communication system, the IMS AS comprising:
a transceiver; and
a controller coupled with the transceiver and configured to:
receive, from a first user equipment (UE), a first message including a first SDP (session description protocol) offer for a first media from the first UE,
transmit, to a data channel signaling function (DCSF) entity, a second message for notifying media change request event,
receive, from the DCSF entity, a third message including information on an avatar media processing, and
transmit, to a second UE, a fourth message including a second SDP offer for a second media from a network entity.

12. The IMS AS of claim 11,
wherein the first message further includes information on processing first metadata for avatar communication, and
wherein the first metadata includes assistance information on at least one of the first media, an extraction of feature points, avatar encoding, or avatar rendering.

13. The IMS AS of claim 11,
wherein the fourth message further includes information on processing second metadata for avatar communication, and
wherein the second metadata includes assistance information on at least one of the second media, an extraction of feature points, avatar encoding, or avatar rendering.

14. The IMS AS of claim 11,
wherein the network entity includes at least one of a media function (MF) entity or media resource function (MRF) entity.

15. The IMS AS of claim 11,
wherein the first message includes a SIP (session initiation protocol) reinvite message, and
wherein the second message includes Nimsas_SessionEventControl_Notify message.

16. A data channel signaling function (DCSF) entity in a wireless communication system, the DCSF comprising:
a transceiver; and
a controller coupled with the transceiver and configured to:
receive, from an IMS (internet multimedia subsystem) AS (application server), a first message for notifying media change request event,
generate a media instruction for an avatar media processing, and
transmit, to the IMS AS, a second message including information on the avatar media processing.

17. The DCSF entity of claim 16,
wherein the first message further includes information on processing first metadata related to the avatar media processing, and
wherein the first metadata includes assistance information on at least one of a media, an extraction of feature points, avatar encoding, or avatar rendering.

18. The DCSF entity of claim 16, wherein the controller is further configured to:
receive, from the IMS AS, a third message including media resource information, and
transmit, to an avatar application server, a first request for application data channel establishment and the media resource information.

19. The DCSF entity of claim 18, wherein the controller is further configured to:
transmit, to the IMS AS, a second request for updating media resource for a network entity.

20. The DCSF entity of claim 19,
wherein the first message includes Nimsas_SessionEventControl_Notify message, and
wherein the network entity includes a media function (MF) entity or media resource function (MRF) entity.
